(19) United States
(12) Patent Application Publication
(10) Pub. No.: US 2014/0046751 A1
(43) Pub. Date: Feb. 13, 2014

(54) Method and System for Displaying Content on a Display of a Client

(71) Applicants: Hisham Abdul Rahim Akbar, Dasma (KW); Talal Th. Al-Yagout, Al Yarmouk (KW); Dawoud G. H. Abdullah, Mishref (KW); Vlad Ciobanu, R-Bucharest (RO)

(72) Inventors: Hisham Abdul Rahim Akbar, Dasma (KW); Talal Th. Al-Yagout, Al Yarmouk (KW); Dawoud G. H. Abdullah, Mishref (KW); Vlad Ciobanu, R-Bucharest (RO)

(73) Assignee: TAWASUL SERVICES CO., Safat (KW)

(21) Appl. No.: 14/001,474

(22) PCT Filed: Dec. 14, 2011
(86) PCT No.: PCT/EP11/72828

§ 371 Date: Nov. 4, 2013

Related U.S. Application Data
(60) Provisional application No. 61/445,881, filed on Feb. 23, 2011.

(51) Int. Cl. G06Q 30/02

(52) U.S. Cl. CPC G06Q 30/0239
USPC 705/14.39

(57) ABSTRACT

Methods, systems, and techniques for providing a benefit in response to being allowed to display content include, for example, displaying, on a portion of the display, a desktop; displaying the content on another portion of the display unoccupied by the desktop; and providing a benefit in exchange for displaying the content. In one example, the content may be advertisements and the benefit may be access to a network such as the Internet.

### TECHNICAL FIELD

The present disclosure is directed at a method and system for displaying content on a display of a client. More particularly, the present disclosure is directed at a method and system for displaying content on a display of a client, such as advertising, in exchange for a benefit such as access to a network.

### BACKGROUND

The importance of the Internet in modern society is difficult to understate. The Internet can be used as a tool that supports and encourages productivity, business, and recreation. Consequently, providing widespread, secure and affordable access to the Internet is and will likely continue to be of great societal importance.

### BRIEF DESCRIPTION OF THE DRAWINGS

In the accompanying drawings, which illustrate one or more exemplary embodiments:

FIG. 1 depicts a system for providing access to a network, according to one embodiment.

FIG. 2 depicts a display of a client, displaying both banner advertisements and a desktop, that is part of the system of FIG. 1.

FIG. 3 depicts the banner advertisements of FIG. 2 on variably sized backgrounds.

FIG. 4 depicts a method for providing access to a network, according to another embodiment.

FIG. 5 depicts a method, which may be used in performing the method of FIG. 4, for connecting to a virtual private network.

FIG. 6 depicts a method, which may used in performing the method of FIG. 4, for displaying advertising on an unoccupied portion of the display.

FIG. 7 depicts a method for modifying an advertising schedule stored in a database, according to another embodiment.

FIG. 8 depicts a display of a system for modifying the advertising schedule stored in the database, according to another embodiment.

### SUMMARY

According to one aspect, there is provided a method for displaying content on a display of a client. The method includes displaying, on a portion of the display, a desktop; displaying the content on another portion of the display unoccupied by the desktop; and providing a benefit in exchange for displaying the content.

Displaying the desktop may include resizing the desktop from occupying an initial portion of the display to occupying a subsequently smaller portion of the display, and the content can be displayed on a portion of the display vacated by the desktop upon resizing. The desktop graphics shown on the display may change in size proportionally with the desktop, or remain the same size before and after the desktop is resized.

The desktop can be delineated by top and bottom sides extending horizontally and left and right sides extending vertically, and the desktop can be horizontally centered on the display. Displaying content may include displaying banner advertisements adjacent to the left and right sides of the desktop. Displaying content may further comprise displaying a banner advertisement adjacent to the bottom side of the desktop, and may even further comprises displaying a taskbar between the content and the edge of the display.

The content may include advertisements overlaid on backgrounds that are larger than the advertisements, and the method may further comprises: resizing the desktop to occupy more or less of the display; and increasing the size of the background when the desktop is decreased in size and decreasing the size of the background when the desktop is increased in size.

The method may further include: resizing the desktop to occupy more or less of the display; and increasing the size of the content when the desktop is decreased in size and decreasing the size of the content when the desktop is increased in size.

The content and a schedule according to which the content is displayed can be stored on a server, and the method may further comprise: prior to displaying the content for a period of time, downloading to the client the content and the schedule for the period of time; and once downloaded, accessing the content and the schedule stored on the client instead of accessing the server.

The content may comprise advertisements that include premium advertisements, and displaying the content may include displaying the premium advertisements prior to any other advertisements.

Furthermore, the content may comprise advertisements and displaying the content may include displaying at each of multiple locations on the display a series of advertisements that periodically transitions from one of the advertisements in the series to another of the advertisements in the series, and transitions of different series of advertisements at different locations on the display are staggered. The method may further include controlling the content remotely from the client.

The method may further include determining whether a benefit provision condition is satisfied. The benefit provision condition is satisfied during situations including when the content will be displayed on the display while the benefit is being provided, and the benefit is provided only when the benefit provision condition is satisfied.

The benefit may include monetary or in-kind consideration. Alternatively, the benefit can include providing access to a network, for example, free access to the Internet.

The vacated space may comprise rectangular space positioned along the border of the shrunken desktop and the vacated space. The shrunken desktop may preserve the relative ratio of desktop graphics displayed thereon before and after being shrunk.

The method may further comprise offering a customer a time slot during which the content may be displayed in exchange for monetary consideration. This can be done through a bid/auction process that allocates the time slot to one of multiple customers who succeeds in the bid/auction process against other customers.

The method may further comprise obtaining targeted data about the user, and the content may include targeted advertising content based on the targeted data.

According to another aspect, there is provided a method for modifying an advertising schedule stored in a database. The advertising schedule comprises: a time slot during which advertising content is to be displayed; and an advertising indicator, associated with the time slot. The indicator indicates whether: a third party advertisement is scheduled to be displayed during the time slot; no advertisement is scheduled to be displayed during the time slot; or a customer advertisement is scheduled to be displayed during the time slot. The method includes: retrieving the advertising schedule from the database; displaying the advertising schedule; when the advertising indicator shows that no third party advertisement is scheduled to be displayed during the time slot, in response to a selection signal toggling the advertising indicator between showing that no advertisement is scheduled to be displayed during the time slot and that the customer advertisement is scheduled to be displayed during the time slot; and updating the database to reflect changes made to the advertising schedule.

A plurality of advertising indicators can be associated with the time slot, and each of the advertising indicators corresponds to a different location on a display on which to display advertising content. Furthermore, the time slot and the advertising indicators can be aligned. The selection signal may comprise an indication of how many of the advertising indicators are to indicate that the customer advertisement is scheduled to be displayed.

Indicating that the third party advertisement is scheduled to be displayed may include identifying a third party associated with the third party advertisement.

According to another aspect, there is provided a method for securely connecting a client to a network. The method include: obtaining client identification information identifying the client; and without relying on subsequent user input, utilizing the client identification information to obtain network credentials to access the network and utilizing the network credentials to connect to the network.

The client identification information may include a civil identification number, a DSL number, or a globally unique client identifier.

The method may further comprise: generating a pair of public and private RSA keys pair at the client; sending the public key to a network provider server; generating an AES key at the network provider server; encrypting the AES key with the public RSA key; sending the encrypted AES key to the client; decrypting the encrypted AES key with the private RSA key; and encrypting subsequent communications with the AES key.

The foregoing methods may also be combined with each other, as appropriate. For example, as part of displaying content on a display, a client may securely connect to a content server that is streaming the content according to a method for securely connecting to a network, as described above.

The foregoing methods may be encoded on to a computer readable medium for execution by a processor, as appropriate. Furthermore, the foregoing methods may be used to configured systems that include both a processor and a computer readable medium so as to cause the systems to perform the methods.

### DETAILED DESCRIPTION

Directional terms such as “top”, “bottom”, “upwards”, “downwards”, “vertically” and “laterally” are used in the following description for the purpose of providing relative reference only, and are not intended to suggest any limitations on how any element is to be displayed during use or relative to an environment.

Providing secure access to a network, such as the Internet, is replete with technological challenges. One such challenge is ensuring that only authorized users have access to the network. Another such challenge is controlling the content that the users who are accessing the network experience. Such content control refers not to censorship, but rather to ensuring that the users see content, over and above the content that the users have explicitly requested, that the network provider wants for them to see. This content can include advertising content, such as banner advertisements, which can beneficially be used by the network provider to offset the costs of providing network access to the users. In one embodiment, by displaying the advertising content the network provider is able to provide network access for free.

The embodiments disclosed below are directed at providing a benefit to a user while displaying content. In some of the embodiments below, the benefit provided to the user is access to a network, while the content displayed to the user is the advertising content. In these embodiments, on any given one of the users' displays the advertising content and the user's desktop are both displayed and do not overlap. The users can consequently view, without obstruction, all the content that they are accessing over the network along with the advertising content that is delivered to them. The following embodiments are also directed at modifying an advertising schedule according to which the advertising content is displayed to the users, and at securely connecting a client to a network.

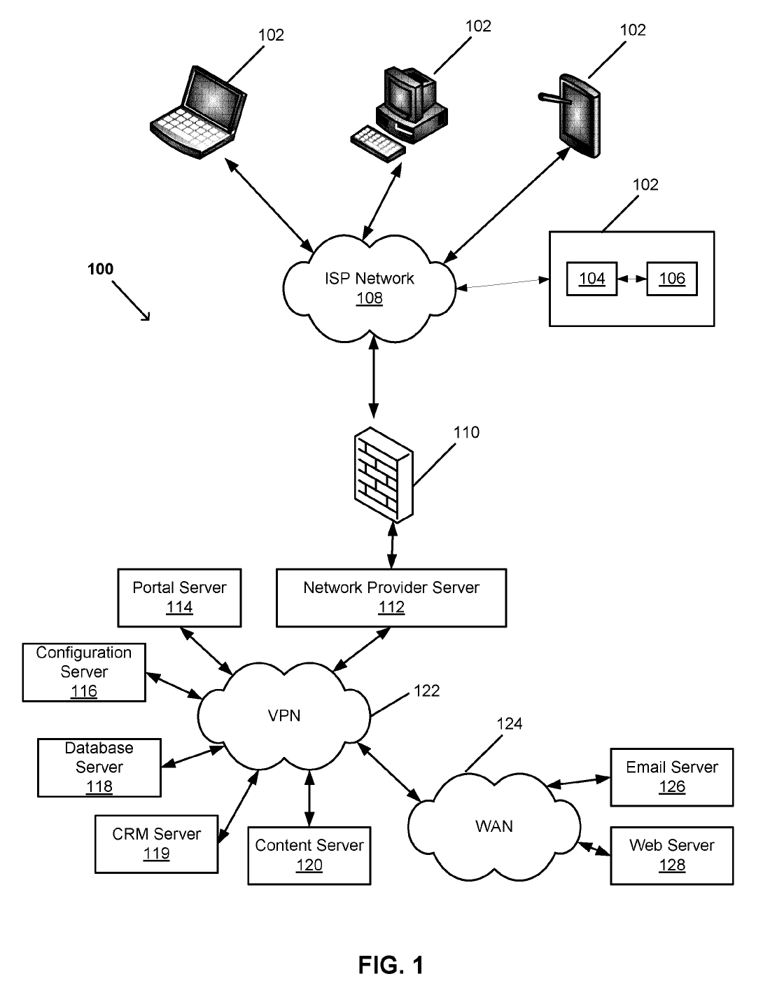

Referring to FIG. 1, there is shown a system 100 for displaying content on a display of a client in exchange for a benefit, according to one embodiment. In the exemplary embodiment of FIG. 1, the benefit is access to a virtual private network (“VPN”) 122. In the embodiment shown in FIG. 1, users interface with the system 100 using clients 102. The clients 102 can be any device that is suitable for accessing the VPN 122 and for displaying advertising. For example, the clients 102 can be a laptop, desktop, or tablet computer; a smartphone or other type of mobile communication device; a media player; or any other suitable device having a processor 104 for executing instructions that are stored on a memory 106. Each of the clients 102 is connected to a network managed by an Internet Service Provider (“ISP network”) 108 via which it can access the VPN 122.

The VPN 122 is connected to the ISP network 108 via a network provider server 112 shielded from the ISP network 108 by a firewall 110. The network provider server 112 negotiates secure connections with the clients 102, disconnects clients 102 whose connections have timed out, and provides the clients 102 with access to the VPN 122 and to the various servers and networks attached to it. The network provider server 112 also includes VPN concentrators (not shown) that are used to direct VPN traffic to the proper destination. Additionally, the network provider server 112 helps to balance the loads borne by the VPN concentrators and the other servers connected to the VPN 122. In the depicted embodiment the VPN 122 allows the clients 102 to access a wide area network (“WAN”) 124, a portal server 114, a configuration server 116, a database server 118, a customer relationship management (“CRM”) server 119, and a content server 120. The VPN concentrators may be, for example, Cisco Systems™ VPN 3000 Concentrators. The network provider server 112 may be, for example, a server outfitted with an appropriate version of Linux™ and Tomcat™ 6.0 with JDK 1.6.

One example of the WAN 124 is the Internet. Via the WAN 124, the clients 102 may be able to access e-mail and web services via an e-mail server 126 and a web server 128, respectively. In an alternative embodiment, the e-mail server 126 and the web server 128 may provide enterprise services that are accessed directly via the VPN 122 without accessing the WAN 124.

As discussed in further detail below, the clients 102 have installed on them client software that is used to ensure that advertising content is displayed on them when they are connected to the VPN 122. The clients 102 can download this client software from the portal server 114. The portal server 114 also allows new users to register their clients 102 using any suitable identifiers, such as a civil identification/social security number and DSL/telephone number, which are used to authenticate the clients 102 when they login through the network provider server 112 to access the VPN 122. The portal server 114 may be, for example, a server outfitted with an appropriate version of Linux™ and Tomcat™ 6.0 with Java™ support.

The content server 120 delivers the content that the network providers want displayed on the clients 102 while they are connected to the VPN 122. As discussed in further detail below, in the depicted embodiment this content takes the form of advertising content and, in particular, banner advertisements. Along with the advertising content, the content server 120 also delivers to the clients 102 schedules according to which the advertising content is displayed. Both the advertising content and the schedules are stored in the database server 118, which is also used to store data generated and utilized by the other servers 112-116. The content server 120 also distributes to the clients 102 periodic updates to the client software. The content server 120 may be, for example, a server outfitted with an appropriate version of Linux™ and Tomcat™ 6.0 with JDK 1.6. The database server 118 may be, for example, a server outfitted with an appropriate version of Linux™ server and PostgreSQL™ database software.

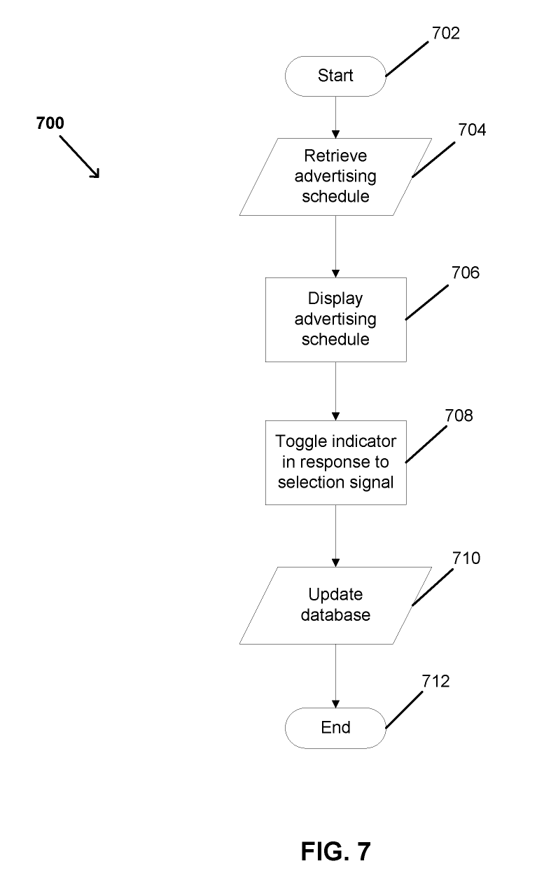

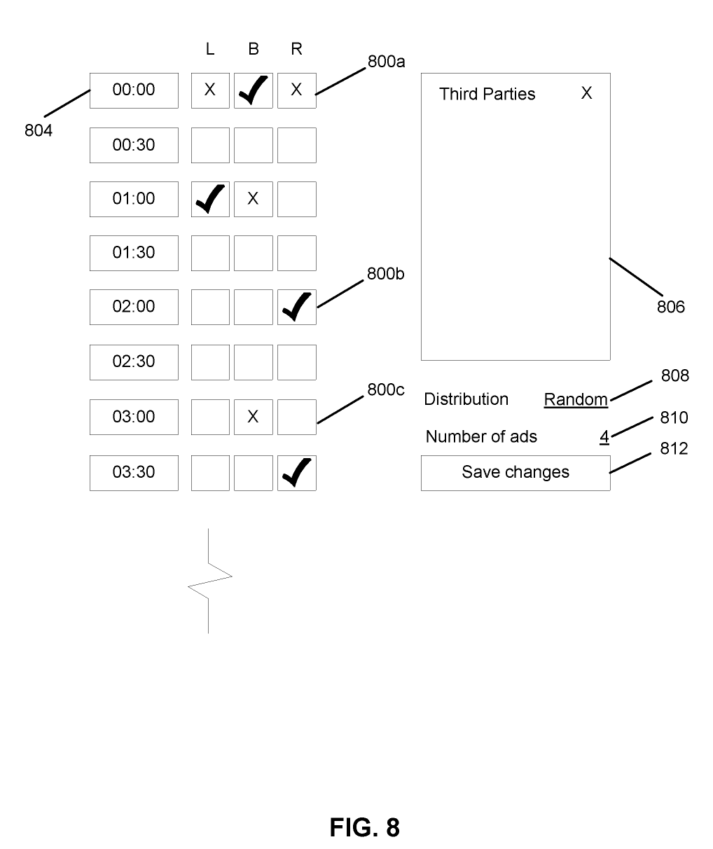

As discussed in greater detail with respect to FIGS. 7 and 8, below, the configuration server 116 in conjunction with the CRM server 119 can be used to add or remove the advertising content from the database server 118 and to modify the schedules according to which the advertising content is displayed. The configuration server 116 can also be used to generate reports on usage of the VPN 122 and on what advertisements have been selected by users with what frequency, to add new versions of the client software, and to otherwise suitably configure the VPN 122 and the servers 112-120. The configuration server 116 may be, for example, a server outfitted with an appropriate version of Linux™ server and Tomcat™ 6.0 with Java™ support.

The CRM server 119 is used to interface with customers (parties seeking to purchase or who have purchased advertising). As discussed with respect to FIG. 8 below, the CRM server 119 presents to the customers an interface through which the customers can modify the schedule according to which the advertising content is displayed. The CRM server 119 relays input received from the customers to the configuration server 116, which then accordingly updates the database server 118. The CRM server 119 also performs other customer interface-related tasks, including but not limited to invoicing; managing complaints; and reporting to the customers advertising content viewing and selection statistics and metrics.

Although the depicted exemplary embodiment shows five different servers 112-120 connected via the VPN 122, in alternative embodiments (not depicted) the functionality of the servers 112-120 may be combined such that fewer than five servers are used without sacrificing functionality, or alternatively such that more than five servers are used to provide identical functionality. Furthermore, in an alternative embodiment (not depicted) the clients 102 may be able to access the WAN 124 directly from the network provider server 112 without first connecting to the VPN 122. Such an embodiment may be particularly useful in embodiments in which security is relatively unimportant.

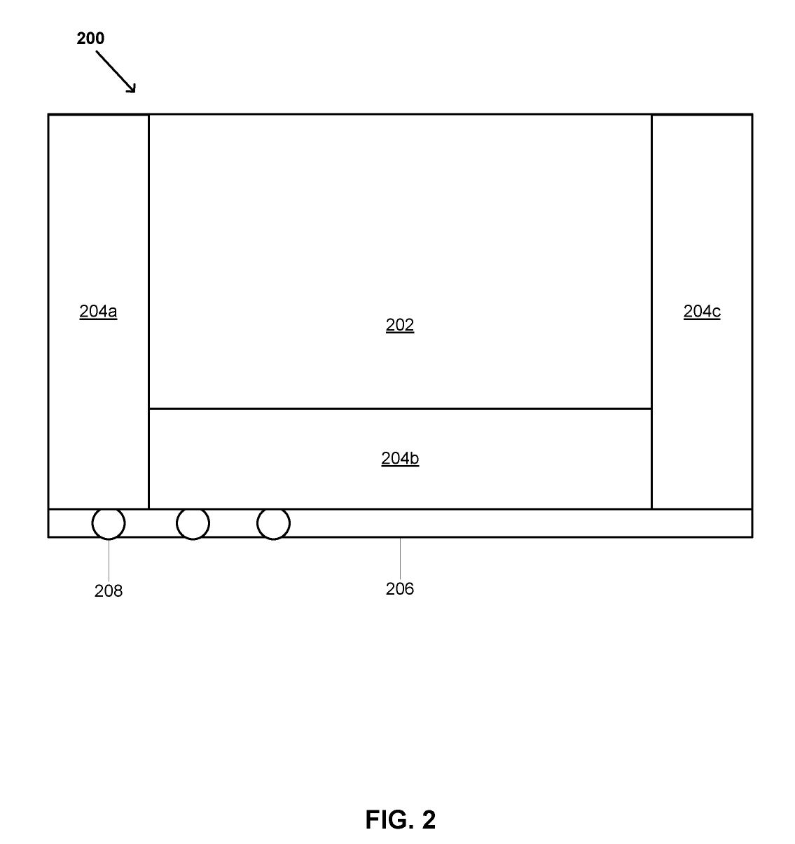

Referring now to FIG. 2, there is shown an exemplary display 200 of one of the clients 102. The display has on it a desktop 202 that has left and right sides extending vertically and top and bottom sides extending horizontally. On the desktop 202 are desktop graphics, which include various icons, windows, applications, and the like (not shown) with which the user may be interfacing using the client 102. The desktop 202 is horizontally centered on the display 200. On the display is the advertising content in the form of three banner advertisements: a left banner advertisement 204a adjacent to the left side of the desktop 202, a right banner advertisement 204c adjacent to the right side of the desktop 202, and a bottom banner advertisement 204b adjacent to the bottom side of the desktop 202 (collectively, the “banner advertisements” 204). The taskbar 206 has on it icons 208 that, for example, allow the users to launch and switch between various programs. As discussed in further detail below, the client software, when running on the clients 102, reconfigures the clients 102 such that the desktop 202 occupies only a portion of the display 200 and the banner advertisements 204 are displayed in the portions of the display 200 unoccupied by the desktop 202.

The desktop 202 and the banner advertisements 204 beneficially do not overlap. Consequently, the entire desktop 202 is visible even while all of the banner advertisements 204 are being displayed. This is advantageous over alternative advertising content display systems in which the advertising content appears on, as opposed to outside of, the desktop 202. Advertising content that appears on the desktop 202 necessarily reduces the proportion of the desktop 202 that can be used to display applications, icons, and the like, which is cumbersome and which can reduce user productivity and enjoyment. The depicted embodiment is also advantageous over systems in which the advertising content is shown only in association with certain applications that actively utilize the VPN 122. For example, in some systems the advertising is shown on the display 200 only when the client 102's web browser is active, as the web browser is the application that primarily accesses the WAN 124. In contrast, in the depicted embodiment the advertising content is always visible regardless of what applications are being run on the client 102 so long as the client software is also being run. Consequently, the advertising content is displayed even when the client 102 is not utilizing an application that requires access to the VPN 122. Furthermore, the entire desktop 202 remains available for use by any running applications.

In the depicted embodiment, the taskbar 206 remains the same size regardless of whether the banner advertisements 204 are displayed. This is beneficial in that the icons 208 on the taskbar 206 are relatively small, and that shrinking the taskbar 206 such that it fits within the desktop 202 would make it difficult for the users to select the icons 208 and to perform actions such as launch applications and switch between windows. In an alternative embodiment (not depicted), however, the taskbar 206 is sized to fit within the desktop 202. In further alternative embodiments (not depicted), the taskbar 206 may be located on the left, top, or right sides of the display 200, and additionally or alternatively may not be visible at all as it may be hidden from view. In such embodiments the sizes of the desktop 202 and the banner advertisements 204 are optionally accordingly repositioned or changed in size so as to occupy the entire display 200.

As discussed in further detail with respect to FIG. 8, below, any of the banner advertisements 204 displayed at any one time is one in a series of advertisements that are shown on the display 200 over a period of time. For example, in the depicted embodiment over the course of an hour 120 of each of the left banner advertisement 204a, the bottom banner advertisement 204b, and the right banner advertisement 204c are shown. Each of the banner advertisements 204 is on the screen for a configurable period of time, which in the depicted embodiment is thirty seconds, before it is replaced by a subsequent banner advertisement. Each time one of the banner advertisements 204 transitions (i.e.: disappears from the display 200 and is replaced by the next banner advertisement 204 in the series of advertisements), the user's attention is naturally drawn to the banner advertisement 204 undergoing transition. In order for the user's attention to be drawn to each of the banner advertisements 204 in turn, the transitions are staggered so that the three banner advertisements 204 do not transition simultaneously. Assuming that the periods between the transitions are equal, using staggered transitions draws the user's entire attention to one of the three banner advertisements 204 every ten seconds, as opposed to having his or her attention split between three simultaneously transitioning banner advertisements 204 every thirty seconds. In the depicted embodiment while each of the banner advertisements 204 transitions every thirty seconds and one of the banner advertisements 204 transitions every ten seconds, in alternative embodiments different transition periods are possible and are customizable by one or both of the network provider and the customer.

Prior to displaying any of the advertising content, the desktop 202 in the depicted embodiment fills the entire display 200. When advertising is to be displayed (e.g.: when the client software is activated), the desktop 202 is resized to fill only a smaller portion of the display 200, as shown in FIG. 2. The banner advertisements 204 are then shown on a portion of the display 200 vacated by the desktop 202 upon resizing. When the client 102 is running the Microsoft Windows™ operating system and the client software is implemented using the Microsoft™.NET Framework, the banner advertisements 204 emulate the behaviour of the Windows taskbar by creating each of them as an application bar using the SHAppBarMessage function. When the banner advertisements 204 are created as application bars, the desktop 202 automatically resizes to fit within the portion of the display 200 delineated by the borders of the banner advertisements 204. Additionally, the banner advertisements 204 are registered as “always on top” application bars, and therefore are displayed in front of any application windows that are moved to overlap with the banner advertisements 204. Consequently, the banner advertisements 204 will always be visible on the display 200. SHAppBarMessage can be called with the ABM_NEW and ABM_SETPOS parameters to create a new application bar in the form of one of the banner advertisements 204 and to set the position of the banner advertisements 204 on the display 200, respectively. Alternatively or additionally, as a failsafe a filter-type dynamic link library may be registered that monitors the movement of application windows on the desktop 202 by monitoring WM_WINDOWPOSITIONCHANGED messages. The windows may then be repositioned to the desktop 202 should they overlap with any of the banner advertisements 204, thus avoiding overlap between the application windows and the banner advertisements 204.

In the embodiment shown in FIG. 2, the portion of the display 200 vacated by the desktop 202 upon resizing is the U-shaped area around the desktop 202 in which the three banner advertisements 204 are shown. In an alternative embodiment (not shown), the desktop 202 may initially occupy a portion of the display 200 that is less than the entire display 200. For example, the initial portion of the display 200 that the desktop 202 occupies may be as shown in FIG. 2, and the desktop 202 may subsequently be resized to occupy only half its initial area and to fit in a smaller portion of the display 200. In an alternative embodiment (not shown), the display 200 may be resized from occupying an initial portion of the display 200 to occupying a subsequently larger portion of the display 200; in this alternative embodiment, the desktop 202 is enlarged to occupy a portion of the display 200 that is vacated by the banner advertisements 204 upon resizing. Regardless of the size of the display 200, the client software is configured such that the desktop 200 and the banner advertisements 204 do not overlap. When the banner advertisements 204 are treated as application bars instantiated using the SHAppBarMessage function, the area of the desktop graphics by default remain the same size before and after the desktop 202 is resized. In an alternative embodiment (not depicted), however, the desktop graphics may change in size proportionally with the desktop 202.

Resizing the desktop 202 may or may not involve changing the resolution of the desktop 202. For example, if the desktop 202 fills the entire display 200 and the display 200 has a resolution of 640×480, then the resolution of the desktop 202 is also 640×480. If the resolution of the display 200 is sufficiently increased and the desktop 202 is resized to occupy a smaller portion of the display 200 so as to allow the banner advertisements 204 to be shown, the resolution of the desktop 202 can remain at 640×480 and occupy less than the entire display 200, thus allowing space on the display 200 for advertising. Conversely, if the resolution of the display 200 remains constant and the desktop 202 is resized to occupy less than the entire display 200 so that advertising may be shown, the resolution of the desktop 202 will decrease.

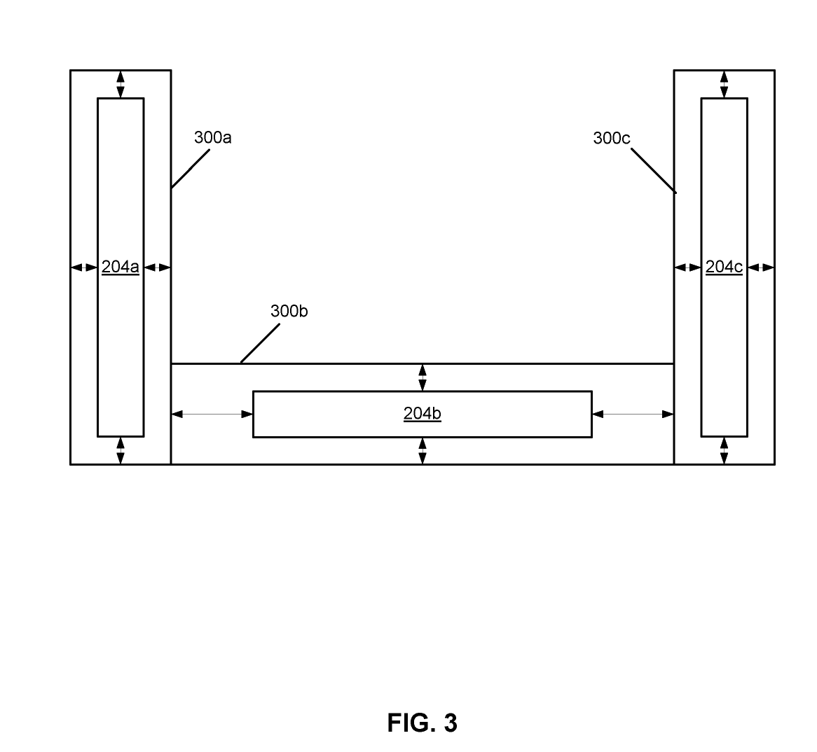

In the depicted embodiment, the size of the banner advertisements 204 remains constant notwithstanding changes in the size of the desktop 202. Referring now to FIG. 3, each of the banner advertisements 204 is overlaid on a background: the left banner advertisement 204a is on a left background 300a; the right banner advertisement 204c is on a right background 300c; and the bottom banner advertisement 204b is on a bottom background 300b (collectively, the “backgrounds” 300). The customer may select the background colour, as discussed with respect to the description of an exemplary XML, schema, below. Each of the banner advertisements 204 is set to a certain resolution, such as 768×128 for the bottom banner advertisement 204b and 128×768 for the left and right banner advertisements 204a,c. Assuming the display 200 has a constant resolution of 1024×768 and that the taskbar 206 is hidden, when advertising is being displayed and the desktop 202 has a resolution of 768×640, the backgrounds 300 are covered entirely by the banner advertisements 204 and are not visible. When the desktop 202 has a resolution of less than 768×640, the backgrounds 300 expand in size so that no unused display area is present between the desktop 202 and the banner advertisements 204. In order for the desktop 202 and the banner advertising 204 not to overlap, when the display 200 is set to a resolution of 1024×768 the desktop 202 has a maximum resolution of 768×640. The backgrounds 300 analogously change in size in embodiments in which the resolution of the display 200 changes. In these embodiments, assuming that the resolution of the desktop 202 remains constant at, for example, 1024×768, if the resolution of the display increases to 2048×1436, the left and right backgrounds 300a,b each expand to 512×1436 while the bottom background 300c expands to 1024×768. In the foregoing embodiments, regardless of whether the display 200 or desktop 202 resolutions are constant, when the desktop 202 is resized to occupy either more or less of the display 200, the sizes of the backgrounds 300 are respectively increased or decreased as well.

In an alternative embodiment (not shown), the backgrounds 300 are not used and instead the banner advertisements 204 themselves increased in size when the desktop 202 is resized to be larger and decreased in size when the desktop 202 is resized to be smaller. For example, in the foregoing example in which the display 200 changes in resolution from 1024×768 to 2048×1436, in this alternative embodiment the left and right banner advertisements 204a,c increase in resolution to 512×1436, while the bottom banner advertisement 204b increases in resolution to 1024×768.

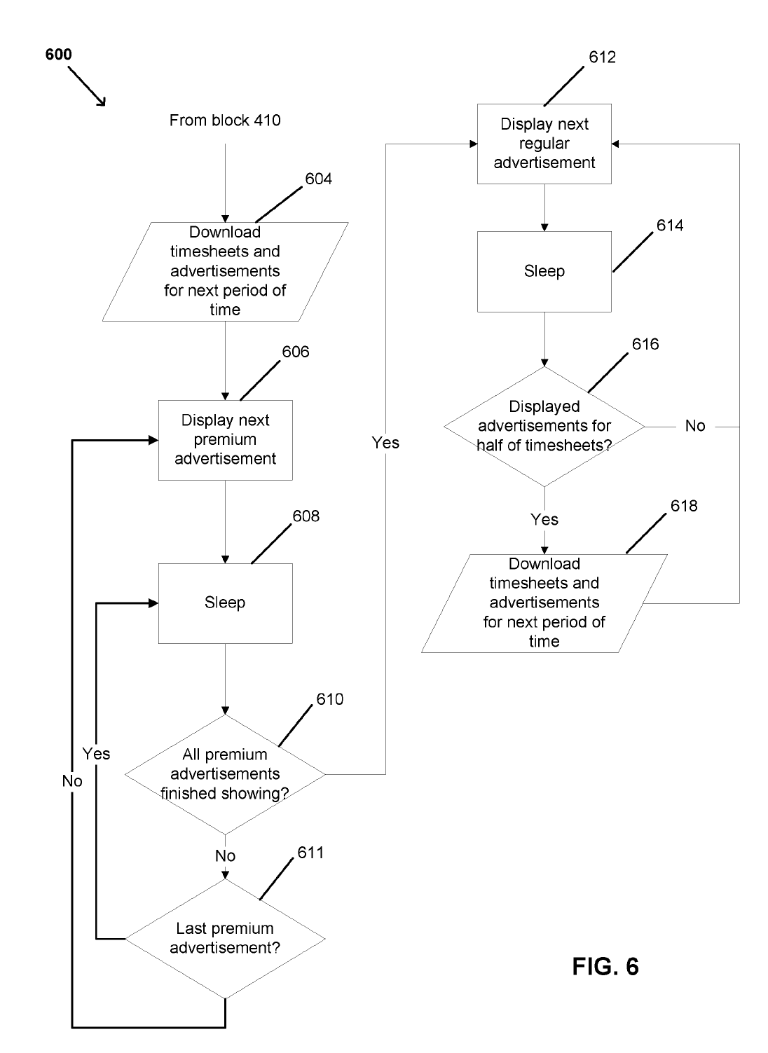

In the depicted embodiment, the communication between the clients 102 and one or both of the network provider server 112 and the content server 120 is performed according to an XML schema. A description of some of the elements used in the XML schema follows:
OS. The OS element is filled by the client 102, and tells the network provider server 112 or the content server 120 the operating system that the client 102 is running. Suitable operating systems include, for example, Microsoft Windows™ and Mac OS X™.
AuthCredentials. The AuthCredentials element is filled by the client 102, and contains authentication data used to identify the client 102 to the network provider server 112. Exemplary authentication data includes the civil identification number, DSL number, and a client identifier that is a unique installation identifier installed by the client software on to the client 102.
ServerTime. The ServerTime element is filled by the network provider server 112 or the content server 120. This element is populated with the date and time, according to the network provider server 112 or the content server 120, at which the XML message is sent. The ServerTime element is used to synchronize all of the clients 102 connected to the network provider server 112 or the content server 120.
Credentials. The Credentials element includes the following child elements, each of which is populated by the network provider server 112 and which is used to establish a connection to the VPN 122:
   Servers. The Servers element specifies the servers with which the client 102 will directly communicate; this is typically the content server 120.
   KeepAliveInterval. This represents the maximum interval between which the client 102 sends a message to the network provider server 112 informing the server the client 102 remains alive and active. If the client 102 does not send the network provider server 112 this message every period of KeepAliveInterval duration, the network provider server 112 terminates the client 102's connection.
   RouterTimeOut. RouterTimeOut represents the maximum time interval the network provider server 112 will wait for any type of message from the client 102 before terminating the client 102's connection to the VPN 122.
   TimeToReport. The TimeToReport element specifies the interval at which the client 102 will periodically send reports of advertising activity, such as which of the banner advertisements 204 have been displayed and which of the advertisements 204 the user has clicked.
   MediaClientVersion. The MediaClientVersion element specifies the newest version of the client software so that the client 102 can know that a software upgrade is possible.
   LastTimesheetModification. The LastTimesheetModification element specifies the last time at which any of the advertising schedules was modified. As discussed in more detail with respect to FIG. 6, below, the client 102 downloads the advertising schedules from the database server 118 prior to displaying the corresponding advertisements 204. If the client 102 has downloaded a schedule from the database server 118 that LastTimesheetModification indicates has since been changed on the database server 118, the client 102 knows to retrieve the updated version of the schedule.
TimesheetInstance. The TimesheetInstance element contains information used to define the advertising schedules, in the form of the following child elements:
   StartTime. The StartTime element is filled by the client 102 and represents the starting date and time at which one of the advertising schedules is downloaded by the client 102. As discussed in further detail below in respect of FIG. 6, in the depicted embodiment the client 102 downloads the advertising schedules from the content server 120 prior to displaying any advertisements listed in the advertising schedule.
   TimeUnit. The network provider server 112 populates the TimeUnit element. The TimeUnit element represents the length in seconds between transitions of the banner advertisements 204.
   TimeLength. The TimeLength element, populated by the network provider server 112, represents the length of the advertising schedule in seconds.
   Data. The Data element, populated by the content server 120, contains the advertising schedule per se; e.g., the information regarding which advertisements are to be displayed on what location on the display 200 and at what times.
ContentInstance. The ContentInstance element, the child elements of which follow and which are either populated by the content server 120 or the client 102, contains information regarding the banner advertisements 204.
   ID. The ID element, populated by the client 102, identifies the banner advertisement 204 being requested.
   EncryptedData. The EncryptedData element, populated by the content server 120, contains the data associated with the ID element that is shown on the display 200.
   ModifiedDate. The ModifiedData element, populated by the content server 120, contains the date that the banner advertisement 204 associated with the ID element was last modified.
   EndDate. The content server 120 populates the EndDate element, which represents the date and time at which the banner advertisement 204 associated with the ID element will expire. Upon expiry, the client 102 deletes the expired banner advertisement 204.
   MD5Signature. The content server 120 populates the MD5Signature element, which represents the MD5 signature of the advertising data associated with the EncryptedData element. This element is used to verify the integrity of the advertisements 204 that have been transmitted to the client 102.
   Background. The Background element is populated by the content server 120 and contains the color of the backgrounds 300 shown on the client 102.
   Type. The content server 120 populates the Type element, which represents whether the banner advertisement 204 is to be displayed vertically, horizontally, or as a screensaver on the display 200.
   Link. Populated by the content server 120, the Link element contains the link to which the user is directed when the banner advertisement 204 is selected.
   Name. The Name element is populated by the content server 120 and is the name associated with the banner advertisement 204 transmitted to the client 102.
   Extension. The Extension element is populated by the content server 120 and represents the type of banner advertisement 204 transmitted to the client 102. In the depicted embodiment, the banner advertisement 204 may be of type .jpg, .png, .gif, .bmp, and .swf.
Customer. The Customer element, populated by both the client 102 and the content server 120, contains information that identifies the customers.
   ID. The ID field is populated by the client 102 and identifies the customer whose advertisements 204 are being requested by the client 102 for download. As mentioned above and as discussed in more detail in respect of FIG. 6 below, the client 102 downloads advertising schedules and the corresponding advertisements 204 prior to displaying them. The client uses the ID field following download of the advertising schedules to indicate which of the customers' advertisements are to be downloaded for display.
   Contents. The Contents field is populated by the content server 120 and represents the list of advertisements belonging to the customer requested by the client 102 and identified by the ID element.

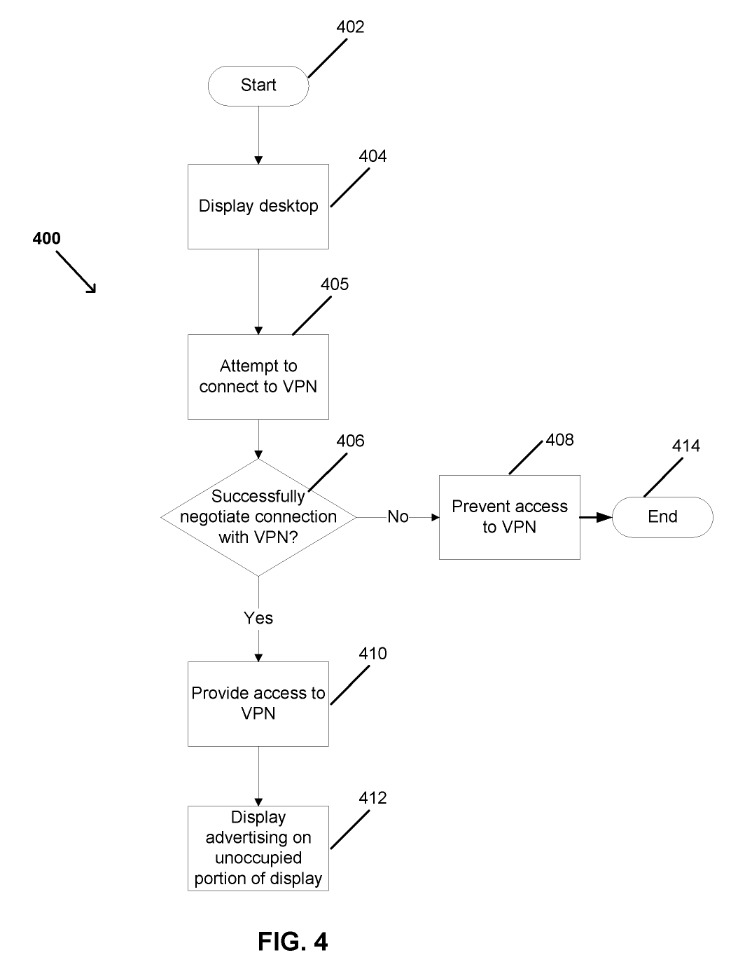

Referring now to FIG. 4, there is shown a method 400 employed by the clients 102 for displaying content in exchange for access to the VPN 122, according to one embodiment. In the depicted embodiment the method 400 is performed by the client 102 as configured by the client software; however, in alternative embodiments (not shown) the method 400 may be performed by the client 102, the network provider server 112 or other servers connected to the VPN 122, or a combination thereof.

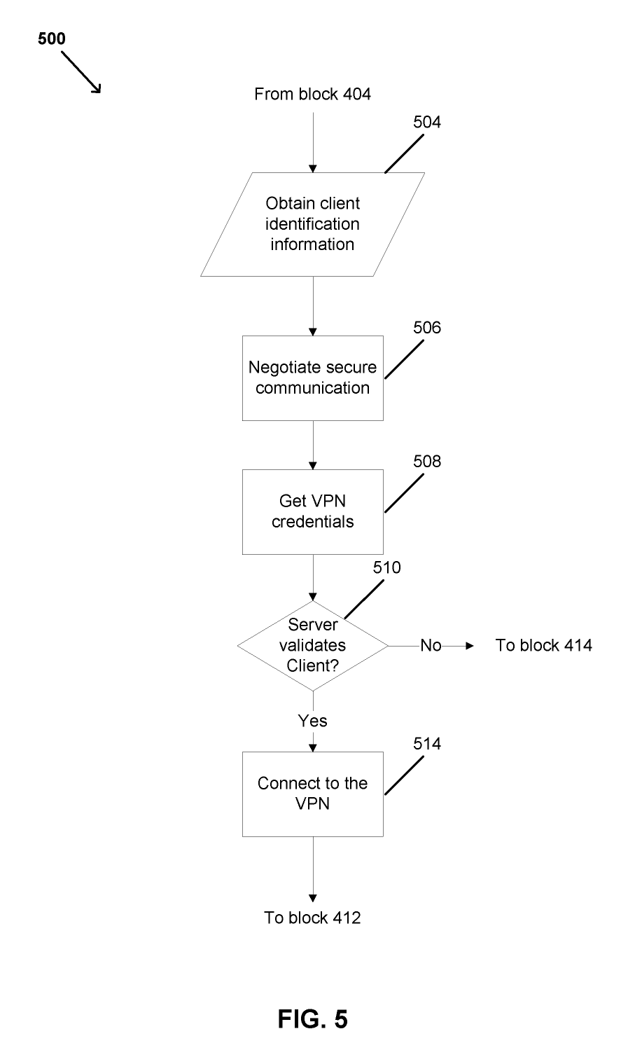

At block 402, the client 102 begins performing the method 400. The client 102 proceeds to block 404 where it displays the desktop 202. Typically, prior to the banner advertisements 204 being displayed, the desktop 202 will fill the entire display 200 with the exception of the taskbar 206. The client 102 then proceeds to block 405 where it attempts to connect to the VPN 122. In the depicted embodiment and as discussed in more detail with respect to FIG. 5, the client 102 automatically attempts to connect to the VPN 122 once launched. The transition from blocks 404 to 405 in FIG. 4 can therefore be triggered by the user launching the client software. At block 406 the client 102 determines whether it has successfully connected to the VPN 122. If not, the network provider server 112 prevents the client 102 from accessing the VPN 122 (block 408), and the method 400 terminates at block 414. If the client 102 has successfully connected to the VPN 122, the network provider server 112 grants the client 102 access to the VPN 122 (block 410) and, as discussed in further detail below in respect of FIG. 6, the banner advertisements 204 are displayed on portions of the display 200 unoccupied by the desktop 202 (block 412).

In the method 400 of FIG. 4, the client 102 is configured to automatically attempt to connect to the VPN 122 after launching, and to automatically display the banner advertisements 204 that are sent to it from the content server 120 via the VPN 122 when connected. Consequently, displaying the banner advertisements 204 follows as a consequence of connecting to the VPN 122. However, in an alternative embodiment displaying the banner advertisements 204 on the client 102 may not follow as a consequence of connecting to the VPN 122. For example, the banner advertisements 204 may be streamed to the client 102 from a separate advertising server (not shown) that connects to the client 102 through a local area network (not shown) or directly through the ISP network 108 instead of via the VPN 122. Consequently, the client 102 may wait until the banner advertisements 204 are received from the advertising server and are being displayed prior to attempting to connect to the VPN 122. In another embodiment (not shown), connecting to the VPN 122 may be permitted without the banner advertisements 204 being displayed, but access to certain ad-supported services via the VPN 122 (e.g.: a television streaming service or the email server 126) may not be allowed without displaying the banner advertisements 204. In this alternative embodiment, the user may be able to select via the client 102 whether to display the banner advertisements 204. When the user permits the banner advertisements 204 to be shown, access to the ad-supported services is granted; access to the ad-supported services is otherwise prohibited. In embodiments in which connecting to the VPN 122 does not consequently result in the banner advertisements 204 being displayed on the client 102, the client 102 can determine whether a network access condition is satisfied prior to allowing access to the ad-supported services. The network access condition is satisfied when the banner advertisements 204 or other advertising content will be displayed on the client 102 while the client 102 is accessing the ad-supported services. For example, in the embodiment discussed above in which the banner advertisements 204 are streamed from the advertising server, the ad-supported service is access to the VPN 122 per se. The network access condition is whether the banner advertisements 204 from the advertising server will be displayed when the VPN 122 is accessed. This condition may be satisfied when, for example, the banner advertisements 204 may be currently displayed and the connection is presumed to be ongoing, or the connection between the advertising server and the client 102 may be established and the client 102 may be configured to retrieve and display the banner advertisements 204 as soon as access to the VPN 122 is granted. Prior to granting access to the VPN 122 either the client 102 or the network provider server 112 determines whether the network access condition is satisfied and permits access to the VPN 122 only if it is satisfied.

Referring now to FIG. 5, there is shown a method 500 for connecting the client 102 to the VPN 122, which is one example of a method that can be performed for blocks 405 to 410 of FIG. 4. At block 504, the client 102 obtains client identification information in the form of, for example, the client 102's civil identification number, DSL number, and a globally unique client identifier. The client identification information may be generated at the time the client software is installed on the client 102, and may be stored in the client 102's memory 106. The client identification information uniquely identifies any one of the clients 102. The client 102 then proceeds to block 506 where it negotiates secure communication with the network provider server 112. The client 102 generates a public/private RSA key pair, and sends the public key to the network provider server 112. The network provider server 112 generates an AES key, which is also used for encryption, and uses the public RSA key to encrypt the AES key. The network provider server 112 then sends the encrypted AES key back to the client 102. The client 102 decrypts the AES key using its private RSA key. The client 102 then uses the AES key to encrypt all subsequent communications with the VPN 122.

The client 102 then proceeds to block 508 at which it obtains network credentials, which in the depicted embodiment are VPN credentials. To do this, the client 102 contacts the network provider server 112, identifying itself using the client identification information. The network provider server 112 validates the client 102 and generates the VPN credentials, which it stores in the database server 118, and then sends the VPN credentials to the client 102. The client 102 then uses the VPN credentials to authenticate itself to the VPN concentrator. The VPN concentrator then verifies the client 102's VPN credentials using a RADIUS server (not shown) that has access to the credentials earlier stored in the database server 118 (block 510). If verification is successful, the client 102 is connected to the VPN 122 (block 514) and proceeds to block 412 where the advertising content is displayed. If verification is unsuccessful, access to the VPN 122 is not granted, the client 102 proceeds to block 414, and the method 400 ends. Beneficially, this method of logging into the VPN 122 allows the client 102 to be initially associated with one set of client identification information at the time of client software configuration, and subsequently allows the client 102 to log into the VPN 122 without having to manually re-enter any client identification information or network credentials.

As mentioned above, in certain embodiments the revenue generated by the banner advertisements 204 allows the network provider to provider access to the VPN 122 to the clients 102 for free; i.e., the clients 102 allowing the banner advertisements 204 to be shown on their displays 102 is the only consideration given in exchange for access to the VPN 122.

Referring now to FIG. 6, there is shown a method 600 for displaying advertising content, such as the banner advertisements 204, on the display 200 of the client 102. At block 604, prior to displaying the banner advertisements 204 for an upcoming period of time, the client 102 downloads from the content server 120 the banner advertisements 204 to be displayed for that period of time and the schedule according to which they are to be displayed. A portion of an exemplary schedule follows:

| Date | Time | Right Banner | Bottom Banner | Left Banner |
|---|---|---|---|---|
| 2011 Jan. 01 | 15:00:00 | 1 | 2 | 3 |
| 2011 Jan. 01 | 15:00:30 | 4 | 5 | 6 |
| . | . | . | . | . |
| . | . | . | . | . |
| . | . | . | . | . |
| 2011 Jan. 01 | 15:59:30 | 178 | 179 | 180 |

In the depicted embodiment, the period of time the schedule covers is one hour (TimeLength=3,600 seconds). The interval between transitions of the banner advertisements 204 is configured, in the depicted exemplary embodiment, to ten seconds (TimeUnit=10 seconds). The schedule starts at 3 pm (StartTime=15:00:00), and the numbers from 1 to 180 identify the banner advertisements 204 to be displayed and where they are to be displayed on the display 200, which is data conveyed in the Data element. The ContentInstance element is used to send the banner advertisements 204 themselves to the client 102.

When the client 102 downloads the scheduling information, it also requests that the content server 120 deliver any premium advertisements that have been purchased by the customers; in the depicted embodiment, the customers purchase the premium advertisement for a particular day, but in alternative embodiments (not depicted) the customers may purchase different premium advertisements to be displayed at different times of day and not simply on different days. The client 102 does this by asking the content server 120 whether it has premium advertisements using, in the depicted embodiment, XML. Premium advertisements are banner advertisements that are more expensive than the regular banner advertisements 204 and that therefore have priority over and are displayed prior to any of the regular banner advertisements 204.

In the above exemplary schedule, the right banner advertisement 204c (advertisement 1) is displayed at 15:00:00, the bottom banner advertisement 204b (advertisement 2) is displayed one TimeUnit later at 15:00:10, and the left banner advertisement 204a (advertisement 3) is displayed one TimeUnit later at 15:00:20. At 15:00:30, advertisement 1 transitions to advertisement 4; at 15:00:40, advertisement 2 transitions to advertisement 5; and at 15:00:50, advertisement 3 transitions to advertisement 6. This continues until advertisement 177 transitions to advertisement 180 at 15:59:50, following which the client 102 displays the banner advertisements 204 according to the next schedule.

Downloading the banner advertisements 204 and the schedules to the client 102 is beneficial in that it allows a relatively large number of the banner advertisements 204 and related scheduling information to be transferred in one extended data transfer as opposed to several shorter data transfers. This can reduce problems related to latency, which can be particularly problematic when customers are paying to have their banner advertisements 204 timely displayed, and allows the advertisements 204 to be displayed without interruption until all of the downloaded advertisements are displayed even if the content server 120 malfunctions.

After the banner advertisements 204 and schedules are downloaded, the client 102 transitions to block 606. At block 606, the client 102 displays the next of the premium advertisements. For example, in the exemplary schedule above, at time 15:00:00 the next advertisement is advertisement 1. At time 15:00:10, the next advertisement is advertisement 2; at time 15:00:20, the next advertisement is advertisement 3, and so on.

After displaying the next premium advertisement, the client 102 performs no action for one TimeUnit (block 608); this allows the banner advertisements 204 to remain on the display 200 for at least one TimeUnit, which is the minimum period between advertisement transitions. At block 610 the client 102 determines whether all of the premium advertisements have finished being displayed; in the depicted embodiment in which each of the banner advertisements 204 is shown for thirty seconds, all the premium advertisements are finished being displayed thirty seconds after the last of the premium advertisements is shown. If yes, then the client 102 transitions to block 612 and begins showing the regular banner advertisements 204. If no, the client 102 determines whether the last of the premium advertisements is currently being displayed (block 611). If the last of the premium advertisements is currently being displayed, then there is no next premium advertisement to display so the client 102 simply returns to block 608 and displays the last of the premium advertisements for another TimeUnit. If the last of the premium advertisements has not yet been shown, then the client 102 returns to block 606 to display the next of the premium advertisements. In the depicted embodiment the banner advertisements 204 and the premium advertisements are displayed for 30 seconds each; in alternative embodiments (not shown), they may be shown for a different, and customer or network provider configurable, duration. In the depicted embodiment, any of the regular banner advertisements 204 that are displaced by the premium advertisements are not shown on the display 200; however, in alternative embodiments (not shown) any displaced regular banner advertisements 204 can be queued and displayed following the premium advertisements.

In the depicted embodiment, customers who want to purchase premium advertisements may do so for any given day. When different premium advertisements are to be displayed on the same day, the content server 120 may decide in what order to display the premium advertisements according to a variety of methods. For example, the content server 120 may decide to show first those premium advertisements that cost the most; that were purchased first; those associated with specific customers; or the content server 120 may randomly display the premium advertisements.

At block 612, the client 102 displays the next of the regular banner advertisements 204, and then sleeps for one TimeUnit as it does in block 608. In the depicted embodiment, it is assumed that once the premium advertisements have all been displayed, there are effectively an unlimited number of regular advertisements to show; i.e., the client 102 can remain connected to the VPN 122 for as long as desired, and will always be shown the banner advertisements 204. In an alternative embodiment, there may be a limited number of the banner advertisements 204 as there are premium advertisements, in which case blocks 612 and 614 can be modified to be analogous to blocks 606 to 611.

At block 616, the client 102 determines whether it has shown half of the most recently downloaded schedule of banner advertisements 204. If so, the client 102 downloads the banner advertisements 204 for the next time period (of duration TimeLength) and their corresponding schedule at 618. In this way, the client 102 reduces the risk that it will ever be out of banner advertisements 204 to display since even if a malfunction occurs the first the time the client 102 attempts to download the banner advertisements 204 for the next time period, half a time period will remain for the client 102 to retry. Once the banner advertisements 204 for the next time period of banner advertisements 204 has been downloaded, the client 102 returns to block 612 and displays the next banner advertisement 204. The client 102 also returns to block 612 and displays the next banner advertisement 204 if less than half the banner advertisements 204 for the current time period have been shown, and there is no reason yet to download the next group of banner advertisements 204.

Referring now to FIG. 8, there is shown an exemplary screenshot of a screen of a system for modifying the advertising content schedule stored in the database server 118, according to another embodiment. The screenshot of FIG. 8 may be shown, for example, when one of the customers is logged into the CRM server 119 to adjust the advertising content schedule.

The screenshot shown in FIG. 8 shows a series of time slots 804 during which the banner advertisements 204 are displayed. Aligned horizontally with each of the slots 804 is a series of three advertising indicators 800: a left banner indicator aligned in a column under the letter “L”; a bottom banner indictor aligned in a column under the letter “B”; and a right banner indicator aligned in a column under the letter “R”. Each of the advertising indicators has three possible states. The first state is when a third party advertisement is scheduled to be displayed during the time slot 804, as shown in one of the indicators 800a. The screenshot of FIG. 8 is typically seen and manipulated by the customer, and a third party advertisement is an advertisement that has been purchased by a different customer than the one viewing the screenshot. In FIG. 8, the indicators 800a show that other third parties “X” have purchased advertisements at 00:00, 01:00 and 03:00; in an alternative embodiment (not shown), other third parties are specifically identified in a legend 806. The second state is when a customer advertisement is scheduled to be displayed during the time slot 804, as shown by another of the indicators 800b. The embodiment of FIG. 8 uses a checkmark to identify those time slots in which the customer has purchased advertising. The third state is when no one—not the customer nor any of the third parties—has yet purchased advertising in the time slot 804. This third state is identified by an empty box, as shown by a third of the indicators 800c. As the third state means that the time slot 804 is open and the customer may book the time slot 804 to display its own banner advertisement 204, the customer may book the time slot 804 by generating a selection signal by selecting the empty indicator 800c associated with that time slot 804 (e.g.: by clicking it with a mouse cursor or, when using a touch sensitive device, by touching it). When selected, the empty indicator 800c toggles to its second state 800b and shows a checkmark. Similarly, the customer may select one of the checkmarks in order to toggle the indicator 800b to its empty state.

In addition to or instead of booking the time slots 804 by selecting specific indicators, the customer may enter a number of time slots 804 to be purchased in a field 810. The CRM server 119 will then automatically populate the indicators 800 either sequentially from the first available slot 804 in the displayed schedule or randomly. In the depicted embodiment, the indicators 800 are populated randomly, as indicated by a distribution indicator 808.

Also on the screen is a save button 812. By selecting the save button 812, the customer can save any changes he or she has made to the schedule to the database server 118, thereby updating the stored version of the schedule.

The screen shown in FIG. 8 depicts one embodiment of a bid/auction process by which various customers can compete against each other to book the time slots 804. In the embodiment shown in FIG. 8, the customers can book the time slots 804 simply by selecting the time slots 804 before any of the other customers and, implicitly or explicitly, agreeing to pay the cost for booking the selected time slots 804. In an alternative embodiment, the bid/auction process may involve, for example, having various customers bid against other for specific time slots with the customer who has entered the highest bid as of a certain deadline winning the right to display its advertising content during the time slot 804.

Referring now to FIG. 7, there is shown a method 700 for modifying the advertising schedule stored in the database server 118, according to another embodiment. At block 702 the method 700 begins. At block 704 the CRM server 119 retrieves the advertising schedule for a certain period of time from the database server 118. At block 706 the CRM server 119 displays the schedule on a screen, as shown in FIG. 8. At block 708 the CRM server 119 responds to the customer's toggling of the indicators 800b,c, which indicate that the customer is modifying the schedule. The customer then selects the save button 812, in response to which the CRM server 119 instructs the configuration server 116 to update the database server 118 with the modified schedule. Once modifications are completed and saved, the method 700 ends at block 712.

In the above-described embodiments in which advertisements are displayed, the advertisements are an example of content and the exemplary benefit that is provided in exchange for allowing advertising to be displayed is access to the VPN 122 or the Internet. As described below, however, in alternative embodiments the content may be content other than advertising, the benefit may be a benefit other than access to the VPN 122, or both.

### ALTERNATIVE EMBODIMENTS AND APPLICATIONS

Several of the foregoing embodiments describe a method and system for displaying content on a display of a client in exchange for a benefit, such as access to a network, and for modifying an advertising schedule stored in a database. In addition to the foregoing embodiments, however, alternative embodiments are possible, examples of which follow.

### Embodiments Directed at Security and Connectivity

As discussed above in respect of FIG. 5, the client 102 is securely logged into the VPN 122 automatically upon launching the client software. The client 102 relies on client identification information such as its civil identification number, DSL number, and globally unique client identifier to identify itself to the network provider server 112 and to obtain the VPN credentials the client 102 uses to login to the VPN 122. This beneficially allows the client 102 to be automatically logged into the VPN 122 after the client software is launched without requiring the user to manually enter client identification information such as a username and password or VPN credentials, which can be tedious.

This method of logging into the VPN 122 may be used to provide access to any secure network or to securely provide access to a system even when no advertising content is displayed on the client 102. For example, the services that can be provided by the secure network or the system that is to be securely accessed may include online travel reservation services; e-learning services; e-banking services; e-commerce services; commodities, stock or other financial market trading services; ship chartering management services; and emergency or national security services.

Securely accessing a network or system as described above is beneficial in several ways. First, the client identification information can be generated upon installation of the client software on the client 102, and can be unique to that client 102 (e.g.: a globally unique identifier may be generated at the time of installation on a particular one of the clients 102). This allows the service provider to have more control over the users who access the secure network or system than if users log in using a username and password combination. For example, the service provider may want to limit logins to a specific client 102, and not allow one user to log in from different clients 102. In this case, the unique client identification information that is generated upon installing the client software on the specific client 102 only allows the user to log in from the client 102 on which the client software was installed. This is advantageous over alternative systems in which users rely on a username and password combination, which can typically be entered from any generic type of terminal.

Additionally, these embodiments of the method for securely connecting to a system or network are beneficial in that after installation of the client software, the users can connect to the system or network (such as the VPN 122) using “one-click” simply by launching the client software. The client software then automatically uses the client identification information to obtain the credentials used to log in to the secure system or network, and then automatically logs into the secure system or network using these credentials. Again, this is beneficial over having to manually enter a username or password combination, and over having to manually enter credentials to access to the secure system or network. Similarly, as users do not have to enter passwords, there is no need to require users to periodically change their passwords in order to maintain an acceptable level of security.

Also beneficially, as the users do not have to manually enter usernames or passwords, in the event that the connection between the client 102 and the network or system is broken, the client 102 can automatically log in again without having to prompt the user.

### Embodiments Directed at Displaying Non-Advertising Content

In addition to displaying the advertising content on the display 200, according to another embodiment any type of content, including non-advertising content, may be shown on the display 200 in a manner analogous to how the banner advertisements 204 are shown on the display 200. This content can include any content that the network provider wishes to have displayed on the display 200 when the client software is running, whether it is related to advertising or not. Examples of this content include a calendar that can be displayed on the display 200 of a secretary so that appointments are not missed; videos taken using security cameras; stock or other financial market information; alarms, telemetry alerts, and other types of signals and indicators in association with, for example, power stations; and newsfeeds.

The network provider may optionally remotely control the content that is shown on the display 200 of the clients 102. For example, the network provider may want to be able to display real-time content in the form of a video announcement from a corporate executive or as a chat box in which the user is able to conference in real-time with users logged in at other clients 102. As additional examples, when the display 200 is being used to show security videos, the network provider may wish to be able to control which video feeds the users are seeing; and when the display 200 is being used to show alarms, the network provider may want to be able to highlight for the user particular alarms that the network provider wants addressed immediately. In the embodiments above in which the banner advertisements 204 are displayed, the network provider may wish to exercise control over the banner advertisements 204 by, for example, replacing one of the banner advertisements 204 for another, keeping one of the banner advertisements 204 displayed for multiple time slots 804, or interacting with the users in some way such as by telling the users they have won a contest. The network provider may remotely control the content by directly interfacing with the content server 120, for example.

In further alternative embodiments, the network provider may be able to remotely control the desktop 202 in addition to or as an alternative to remotely controlling the content. For example, the network provider may be able to control when the desktop 202 is resized from occupying the entire display 200 to occupying only a portion of the display 200 so as to enable the content to be shown in the space on the display 200 vacated by the desktop 202 upon resizing. Similarly, the network provider may be able to control when the content disappears from the display 200 and when the desktop 202 is accordingly resized to again occupy the entire display 200. The network provider's control of either or both of the desktop 202 and the content may be exclusive. For example, instead of having the desktop 202 automatically resize and the content automatically appear upon launching of the client software, the clients 102 may be configured to always be running the client software, and the client software may be configured so as to shrink the desktop 202 to allow for the display of the content or to enlarge the desktop 202 when the content is to no longer be displayed in response to commands from the network provider as opposed to users of the clients 102. To implement this, the client software may be incorporated as part of the operating system of the clients 102, or the client software may be separate from the client 102 operating system but may be launched immediately following start-up of the client 102, for example.

### ADDITIONAL APPLICATIONS

Embodiments of the foregoing method and system may also be used to provide access to networks used to deliver IPTV or satellite transmissions, or to cable networks used to provide access to any one or more of pay-per-view events, video on demand, and subscription based television services. In such embodiments, the display 200 may be, for example, a television. In such embodiments, instead of displaying the banner advertisements 204 as in some of the foregoing embodiments, the network provider may choose to analogously display news, sports, and other similar bulletin services from certain customers. These customers would receive benefit by virtue of providing and being associated with these bulletin services, and the users receive benefit by receiving partially or completely subsidized access to the video transmission.

The content that is displayed may also include prompts related to interactive television. For example, in interactive television the users may be shown a program via the desktop 202, and around the desktop 202 in lieu of the banner advertisements 204 may be displayed interactive prompts to the users regarding how they would like the program to proceed.

The foregoing methods and systems may also be used during voting. For example, the desktop 202 may be used to display biographical information on various candidates or other information pertinent to the election, and around the desktop 202 in lieu of the banner advertisements 204 the users may be prompted to vote, by selecting differently delineated areas around the desktop 202, for a certain candidate.

The foregoing methods and systems may also be used on aircraft entertainment systems. When passengers view video content such as television shows and movies on the aircraft, the banner advertisements 204 or other advertising content may also be displayed, thereby increasing airline revenue.

As mentioned above, the embodiments described herein may also be used in conjunction with e-learning services. The advertising content may be displayed while lessons are provided on the desktop 202. Alternatively, in lieu of displaying the advertising content, the lessons themselves may be presented. For example, in lieu of the banner advertisements 204, differently delineated areas around the desktop 202 may be used to display interactive tutorials using, for example, Flash™ or HTML5; lectures; exam preparation material; and various other training materials.

In another alternative embodiment, specially designed kiosks may be configured to display certain types of information while simultaneously displaying the banner advertisements 204 or other types of the advertising content in order to generate revenue. For example, the desktop 202 of a travel kiosk may be used to display information related to local hotels, shopping malls, and airports, with the operation of the travel kiosk being supported by advertising revenue generated by sale of the advertising content.

In another alternative embodiment, there is provided a method and system for providing any suitable benefit or reward to a user in exchange for displaying content on the display 200 in the area around the desktop 202. This alternative embodiment is substantially similar to the embodiments depicted in FIGS. 1 through 6 and discussed above, but instead of only advertising content being shown other types of content may also be shown, and instead of access to the VPN 122 being provided other benefits or rewards may also be provided. While the content may be the advertising content and the benefit may be access to a network or a system, such as the VPN 122, the content may also be non-advertising content, and additionally or alternatively the benefit may be a benefit other than access to a network or a system.

For example, in certain embodiments when the content is the advertising content, the benefit may be monetary (the user may be paid a certain amount for viewing a certain number of the banner advertisements 204 over a certain period) or in-kind consideration. Exemplary types of in-kind consideration include points, such as travel points, that can be used in conjunction with a loyalty program; coupons for discounted goods and services; prizes, such as tangible goods; and credits for use in online stores. In another alternative embodiment, the users may receive monetary or in-kind consideration for clicking on or otherwise selecting the advertising content.

As discussed above, when the benefit is providing access to the VPN 122 in certain embodiments the client 102 can determine whether the network access condition is satisfied. More generally, in embodiments in which the benefit or reward being provided is not access to the VPN 122 or other network, the client 102 may determine whether a benefit provision condition is satisfied. For example, when the benefit being provided is points for a loyalty program, the benefit provision condition may be whether the user associated with the client 102 is a member of the loyalty program. If not, providing the benefit is useless. Alternatively or additionally, several types of benefits may be provided, and the client 102 or servers 112-120 may employ a decision making process to determine which of the benefits to provide. For example, the client 102 may have targeted data or information relating to the preferences of the user currently using the client 102. The targeted data may reveal, for example, that although the user is a member of both dining and traveling loyalty programs, that the user flies much more frequently than he eats at restaurants. Consequently, the client 102 may request a targeted benefit in the form of traveling points as opposed to dining points. Similarly, the client 102 also request targeted advertising content from the content server 120 in the form of tourism or airline banner advertisements 204. If the content being shown is not the advertising content, the client 102 may request other types of targeted content. For example, when e-learning services are being provided, the client 102 may request targeted content in the form of cooking instruction when the user associated with the client 102 has indicated an interest in cooking. Consequently, based on user information related to the user interfacing with the client 102, one or both of targeted benefits and targeted content may be shown on the client 102.

Any of the foregoing methods can be stored on a computer readable medium for execution by a any suitable controller, such as a processor, microcontroller, programmable logic controller, field programmable gate array, or can be implemented in hardware using, for example, an application-specific integrated circuit. For example, in the embodiment depicted in FIG. 1 the clients 102 have a processor 104 communicatively coupled to a memory 106, which is a type of computer readable medium, that has encoded thereon statements and instructions to cause the clients 102 to execute any of the foregoing embodiments of methods. Exemplary computer readable media include disc-based media such as CD-ROMs and DVDs, magnetic media such as hard drives and other forms of magnetic disk storage, semiconductor based media such as flash media, random access memory, and read only memory.

For the sake of convenience, the exemplary embodiments above are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

FIGS. 4 to 7 are flowcharts of exemplary methods. Some of the blocks illustrated in the flowchart may be performed in an order other than that which is described. Also, it should be appreciated that not all of the blocks described in the flow chart are required to be performed, that additional blocks may be added, and that some of the illustrated blocks may be substituted with other blocks.

While particular embodiments have been described in the foregoing, it is to be understood that other embodiments are possible and are intended to be included herein. It will be clear to any person skilled in the art that modifications of and adjustments to the foregoing embodiments, not shown, are possible.

1. A method for displaying content on a display of a client, the method comprising:
(a) displaying, on a portion of the display, a desktop;
(b) displaying the content on another portion of the display unoccupied by the desktop; and
(c) providing a benefit in exchange for displaying the content.

2. A method as claimed in claim 1 wherein displaying the desktop comprises resizing the desktop from occupying an initial portion of the display to occupying a subsequently smaller portion of the display, and wherein the content is displayed on a portion of the display vacated by the desktop upon resizing.

3. A method as claimed in claim 2 wherein desktop graphics change in size proportionally with the desktop.

4. A method as claimed in claim 2 wherein desktop graphics remain the same size before and after the desktop is resized.

5. A method as claimed in claim 1 wherein the desktop is delineated by top and bottom sides extending horizontally and left and right sides extending vertically, and wherein the desktop is horizontally centered on the display.

6. A method as claimed in claim 5 wherein displaying content comprises displaying banner advertisements adjacent to the left and right sides of the desktop.

7. A method as claimed in claim 6 wherein displaying content further comprises displaying a banner advertisement adjacent to the bottom side of the desktop.

8. A method as claimed in claim 7 further comprising displaying a taskbar between the content and the edge of the display.

9. A method as claimed in claim 1 wherein the content comprises advertisements overlaid on backgrounds that are larger than the advertisements, and further comprising:
(a) resizing the desktop to occupy more or less of the display; and
(b) increasing the size of the background when the desktop is decreased in size and decreasing the size of the background when the desktop is increased in size.

10. A method as claimed in claim 1 further comprising:
(a) resizing the desktop to occupy more or less of the display; and
(b) increasing the size of the content when the desktop is decreased in size and decreasing the size of the content when the desktop is increased in size.

11. A method as claimed in claim 1 wherein the content and a schedule according to which the content is displayed are stored on a server, and further comprising:
(a) prior to displaying the content for a period of time, downloading to the client the content and the schedule for the period of time; and
(b) once downloaded, accessing the content and the schedule stored on the client instead of accessing the server.

12. A method as claimed in claim 1 wherein the content comprises advertisements that include premium advertisements, and wherein displaying the content comprises displaying the premium advertisements prior to any other advertisements.

13. A method as claimed in claim 1 wherein the content comprises advertisements and wherein displaying the content comprises displaying at each of multiple locations on the display a series of advertisements that periodically transitions from one of the advertisements in the series to another of the advertisements in the series, and wherein transitions of different series of advertisements at different locations on the display are staggered.

14. A method as claimed in claim 1 further comprising controlling the content remotely from the client.

15. A method as claimed in claim 1 further comprising determining whether a benefit provision condition is satisfied, wherein the benefit provision condition is satisfied during situations including when the content will be displayed on the display while the benefit is being provided, and wherein the benefit is provided only when the benefit provision condition is satisfied.

16. A method as claimed in claim 1 wherein the benefit comprises monetary or in-kind consideration.

17. A method as claimed in claim 1 wherein the benefit comprises providing access to a network.

18. A method as claimed in claim 17 wherein the benefit comprises providing free access to the Internet.

19. A method as claimed in claim 2 wherein the vacated space comprises rectangular space positioned along the border of the shrunken desktop and the vacated space.

20. A method as claimed in claim 19 wherein the shrunken desktop preserves the relative ratio of desktop graphics displayed thereon before and after being shrunk.

21. A method as claimed in claim 1 further comprising offering a customer a time slot during which the content may be displayed in exchange for monetary consideration.

22. A method as claimed in claim 21 wherein offering a time slot comprises a bid/auction process that allocates the time slot to one of multiple customers who succeeds in the bid/auction process against other customers.

23. A method as claimed in claim 1 further comprising obtaining targeted data about the user, wherein the content comprises targeted advertising content based on the targeted data.

24-31. (canceled)

32. A method as claimed in claim 1 further comprising, prior to displaying the content, connecting the client to a network by performing a method comprising:
(a) obtaining client identification information identifying the client; and
(b) without relying on subsequent user input:
(i) utilizing the client identification information to obtain network credentials to access the network; and
(ii) utilizing the network credentials to connect to the network.

33. A system for displaying content on a display, the system comprising:
(a) a processor;
(b) a display, communicatively coupled to the processor; and
(c) a memory, communicatively coupled to the processor, and having encoded thereon statements and instructions to cause the processor to execute a method comprising:
(i) displaying, on a portion of the display, a desktop;
(ii) displaying the content on another portion of the display unoccupied by the desktop; and
(iii) providing a benefit in exchange for displaying the content.

34-35. (canceled)

36. A non-transitory computer readable medium having encoded thereon statements and instructions to cause a processor to execute a method for displaying content on a display of a client, the method comprising:
(a) displaying, on a portion of the display, a desktop;
(b) displaying the content on another portion of the display unoccupied by the desktop; and
(c) providing a benefit in exchange for displaying the content.
